(19) United States
(12) Patent Application Publication
(10) Pub. No.: US 2019/0030715 A1
(43) Pub. Date: Jan. 31, 2019

(54) ROBOT CONTROLLER AND PRODUCTION SYSTEM

(71) Applicant: FANUC CORPORATION, Yamanashi (JP)

(72) Inventor: Yoshihiko TARUI, Yamanashi (JP)

(21) Appl. No.: 15/986,139

(22) Filed: May 22, 2018

(30) Foreign Application Priority Data
Jul. 27, 2017 (JP) 2017-145406

(51) Int. Cl. B25J 9/16

(52) U.S. Cl. CPC B25J 9/1664; Y10S 901/03; B25J 9/163; B25J 9/1692

(57) ABSTRACT

A robot controller which can simply perform the teaching of a movement position included in a task of producing a robot operation program. A robot controller which controls a robot includes: a numerical controller which is connected so as to be able to perform communication; a signal reception unit which receives a preset external signal from the numerical controller; a program storage unit which stores a setup program that is previously made to correspond to the external signal; and a program start unit which starts the setup program that is previously made to correspond to the external signal when the program start unit receives the external signal from the numerical controller through the signal unit, where when the setup program is started, the current position of the robot is used as a teaching position to be stored in a position register previously set in the setup program.

This application is based on and claims the benefit of priority from Japanese Patent Application No. 2017-145406, filed on 27 Jul. 2017, the content of which is incorporated herein by reference.

### BACKGROUND OF THE INVENTION

### Field of the Invention

The present invention relates to a robot controller and a production system.

### Related Art

Recently, in machining using a machine tool, in order to reduce a cycle time, an industrial robot has been used for a task of fitting and removing a work. The machine tool and the robot used in the machining are individually controlled by controllers. Here, a controller for a general machine tool such as a lathe or a machining center is referred to as a machine tool controller. In the case of a dedicated machine tool which is designed for a specific application, PLC (Programmable Logic Controller) software is executed in the machine tool controller.

The machine tool controller generally includes a display and an operator's panel for operating the machine tool. The display and the operator's panel are often fixedly installed in a forward position of the machine tool so that it is possible to visually check machining conditions. On the other hand, a controller for a robot is referred to as a robot controller. The robot controller includes a teach pendant which can be carried by a user and which is used for operating the robot.

Even in the case of each of the controllers for the machine tool and the robot, a target which is displayed and operated by the display and the operator's panel provided in the controller is generally limited to the machine tool or the robot which is controlled by the controller. In order to establish a system which is formed with the machine tool and the robot described above, it is necessary to make settings on the side of the robot including the production of a machining program for the machine tool. A setting task on the side of the robot necessary for the establishment of the system includes, for example, a setting for network connection, the assignment of signals and an operation of producing a robot operation program. Here, the task of producing the robot operation program includes the production of an operation sequence, the input of necessary numerical parameters and the teaching of a movement position. Although the setting task on the side of the robot needs to be performed on the teach pendant of the robot, the user of the machine tool is unfamiliar with the handing of the teach pendant in the robot and has difficulty in directly making settings by himself. For example, a connected system of a robot and a machine which makes it possible to operate the robot with a machine control unit is disclosed (for example, Patent Document 1).

Patent Document 1: Japanese Unexamined Patent Application, Publication No. 2001-154717

### SUMMARY OF THE INVENTION

In the invention disclosed in Patent Document 1, it is assumed that in the control unit 12 of an injection molding machine 10 incorporating a robot 20, various types of programs for operating the robot 20 are stored, and an operation program for the robot is produced in the control unit 12 of the injection molding machine 10. Then, the operation program for the robot produced in the control unit 12 of the injection molding machine 10 is transmitted to the control unit 22 of the robot. As described above, it is difficult to apply the invention disclosed in Patent Document 1 to the conventional machine tool controller without being changed. By contrast, the applicant has filed an application of an invention for simplifying the production of an operation sequence and the input of necessary numerical parameters included in a task of producing a robot operation program (Japanese Patent Application No. 2017-098040). Hence, a robot controller and a production system are required in which functions included in the conventional machine tool controller and the conventional robot controller are used, and in which it is thus possible to simply perform the teaching of a movement position included in a task of producing a robot operation program.

In order to solve the problem described above, the present invention has an object to provide a robot controller and. a production system in which a setup program for storing a teaching position on the side of the robot controller and a robot operation program are previously incorporated such that on the side of a machine tool controller, an I/O function used for communication between the conventional machine tool controller and the robot controller is appropriated without being changed, and in which the setup program is started so as to make it possible to perform the teaching of the movement position of the robot.

(1) A robot controller (for example, a “robot controller 400” which will be described later) of the present invention which controls a robot (for example, a “robot 300” which will be described later) includes: external equipment (for example, a “numerical controller 100” which will be described later) which is connected so as to be able to perform communication; a signal reception unit (for example, a “signal reception unit 410” which will be described later) which receives a preset external signal from the external equipment; a program storage unit (for example, a “program storage unit 430” which will be described later) which. stores a setup program (for example, a “setup program 450” which will be described later) that is previously made to correspond to the external signal; and a program start unit (for example, a “program start unit 420” which will be described later) which starts the setup program that is previously made to correspond to the external signal when the program start unit receives the external signal from the external equipment through the signal reception unit, where, when the setup program is started, the current position of the robot is used as a teaching position to be stored in a position register previously set in the setup program.

(2) Preferably, the external equipment described in (1) includes: a display unit (for example, a “display 70” which will be described later); a teaching position display control unit (for example, a “teaching position. display control unit 110” which will be described later) which displays, on the display unit, only a teaching position that needs to be taught this time to the robot; a robot axis feed unit (for example, a “robot axis feed unit 120” which will be described later) which operates an axis of the robot; and a signal transmission unit (for example, a “signal transmission unit 140” which will be described later) which transmits, to the robot controller, the external signal that is previously made to correspond to the teaching position, where the teaching position display control unit displays, on the display unit, only a teaching position that needs to be subsequently taught to the robot when the signal transmission unit transmits the external signal to the robot controller.

(3) Preferably, in the robot controller (for example, a “robot controller 400” which will be described later) described in (2), the teaching position display control unit further displays the completion of position teaching on the display unit when the signal transmission unit transmits, to the robot controller, the external signal that is made to correspond to a final teaching position.

(4) Preferably, in the robot controller (for example, a “robot controller 400” which will be described later) described in any one of (1) to (3), the program storage unit further stores a robot operation program (for example, a “operation program 460” which will be described later) for moving the robot, the program start unit further starts the robot operation program and when the robot operation program is started, the position register in which the teaching position is stored is called by the setup program.

(5) Preferably, in the robot controller (for example, a “robot controller 400” which will be described later) described in any one of (1) to (4), the external equipment is a machine tool controller (for example, a “numerical controller 100” which will be described later).

(6) A production system (for example, a “production system 1000” which will be described later) of the present invention includes: a robot controller (for example, a “robot controller 400” which will be described later) which controls a robot (for example, a “robot 300” which will be described later); and a machine tool controller (for example, a “numerical controller 100” which will be described later) which is connected to the robot controller so as to control a machine tool that is used by being combined with the robot, where the machine tool controller includes: a display unit (for example, a “display 70” which will be described later); a teaching position. display control unit. (for example, a “teaching position display control unit 110” which will be described later) which displays, on the display unit, only a teaching position that needs to be taught this time to the robot; a robot axis feed unit (for example, a “robot axis feed unit 120” which will be described later) which operates an axis of the robot; and a signal transmission unit (for example, a “signal transmission unit 140” which will be described later) which transmits, to the robot controller, an external signal that is previously made to correspond to the teaching position, the teaching position display control unit displays, on the display unit, only a teaching position that needs to be subsequently taught to the robot when the signal transmission unit transmits the external signal to the robot controller, the robot controller includes: a signal reception unit (for example, a “signal reception. unit 410” which will be described. later) which receives the preset external signal from the machine tool controller; a program storage unit (for example, a “program storage unit 430” which will be described later) which stores a setup program (for example, a “setup program 450” which will be described later) that is previously made to correspond to the external signal; and a program. start unit (for example, a “program start unit 420” which will be described later) which starts the setup program that is previously made to correspond to the external signal when the program start unit receives the external signal from the machine tool controller through the signal reception unit, and when the setup program is started, the current position of the robot is used as a teaching position to be stored in a position register previously set in the setup program.

According to the present invention, it is possible to provide a robot controller and a production system in which a setup program for storing a teaching position on the side of the robot controller and a robot operation program are previously incorporated such that on the side of a machine tool controller, an I/O function used for communication between the conventional machine tool controller and the robot controller is appropriated without being changed, and in which the setup program is started so as to make it possible to perform the teaching of the movement position of a robot.

### BRIEF DESCRIPTION OF THE DRAWINGS

FIG. 1 is a schematic diagram showing the system configuration of a production system according to an embodiment of the present invention;

FIG. 2 is a block diagram showing the configuration of a numerical controller;

FIG. 3 is a diagram showing individual axes and orthogonal axes in a robot 300;

FIG. 4 is a diagram showing an example of the movement position of the robot 300;

FIG. 5A is a diagram showing an example of a setup program which is executed by a robot controller;

FIG. 5B is a diagram showing an example of an operation program which is executed by the numerical controller;

FIG. 6 is a diagram showing an example of a screen related to a position teaching operation which is executed by the numerical controller;

FIG. 7 is a diagram showing an example of a screen related to a manual operation of the robot which is executed by the numerical controller;

FIG. 8A is a diagram showing an example of a teaching position display screen corresponding to the operation sequence of the robot;

FIG. 8B is a diagram showing an example of the setup program started by the teaching position display screen corresponding to the operation sequence of the robot;

FIG. 9A is a diagram showing an example of the teaching position display screen corresponding to the operation sequence of the robot;

FIG. 9B is a diagram showing an example of the setup program started by the teaching position display screen corresponding to the operation sequence of the robot;

FIG. 10A is a diagram showing an example of the teaching position display screen corresponding to the operation sequence of the robot;

FIG. 10B is a diagram showing an example of the setup program started by the teaching position display screen corresponding to the operation sequence of the robot;

FIG. 11 is a diagram showing an example of a teaching position display screen showing the completion of a teaching task; and

FIG. 12 is a diagram showing an example of an operation program corresponding to the operation sequence of the robot.

### DETAILED DESCRIPTION OF THE INVENTION

### Embodiment

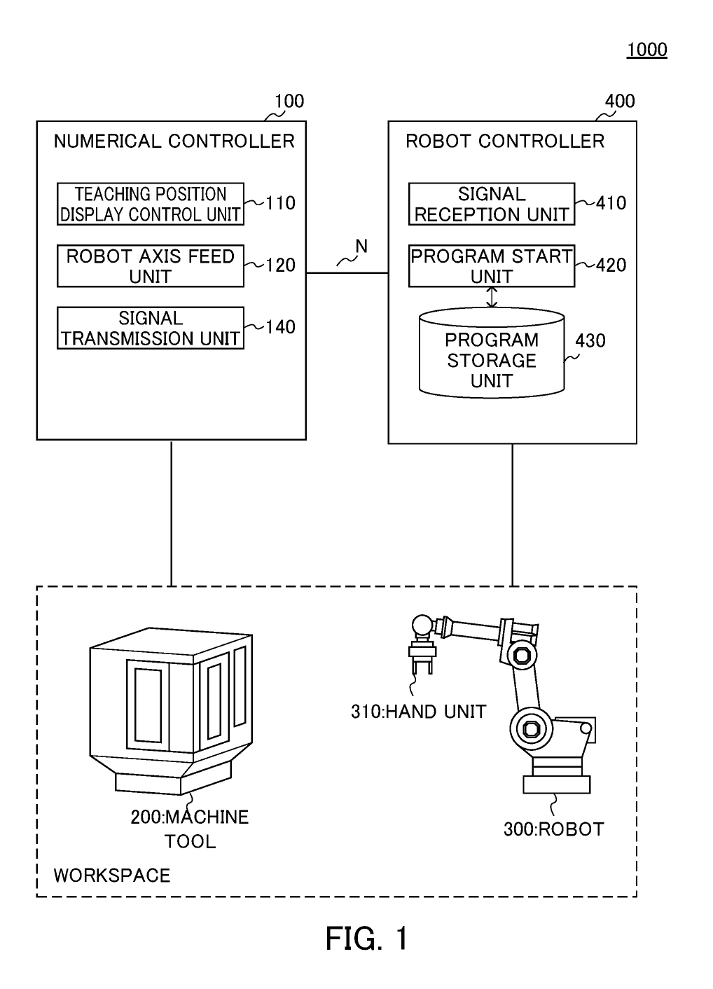

The configuration of a production system 1000 according to the present embodiment will be described. FIG. 1 is a schematic diagram showing the system configuration of the production system 1000 according to the embodiment of the present invention. Although in the present embodiment, as external equipment, a numerical controller 100 is illustrated, the external equipment is not limited to the numerical controller. As shown in FIG. 1, the production system 1000 includes: the numerical controller (CNC: Computerized Numerical Control) 100; a machine tool 200; a robot 300; and a robot controller 400. The numerical controller 100 and the machine tool 200, the numerical controller 100 and the robot controller 400 and the robot controller 400 and the robot 300 are individually, for example, directly connected together through a connection interface or connected through a network such as a LAN (Local Area Network) so as to be able to communicate with each other. A specific communication method in the network, which one of wired. connection and wireless connection is used and the like are not particularly limited.

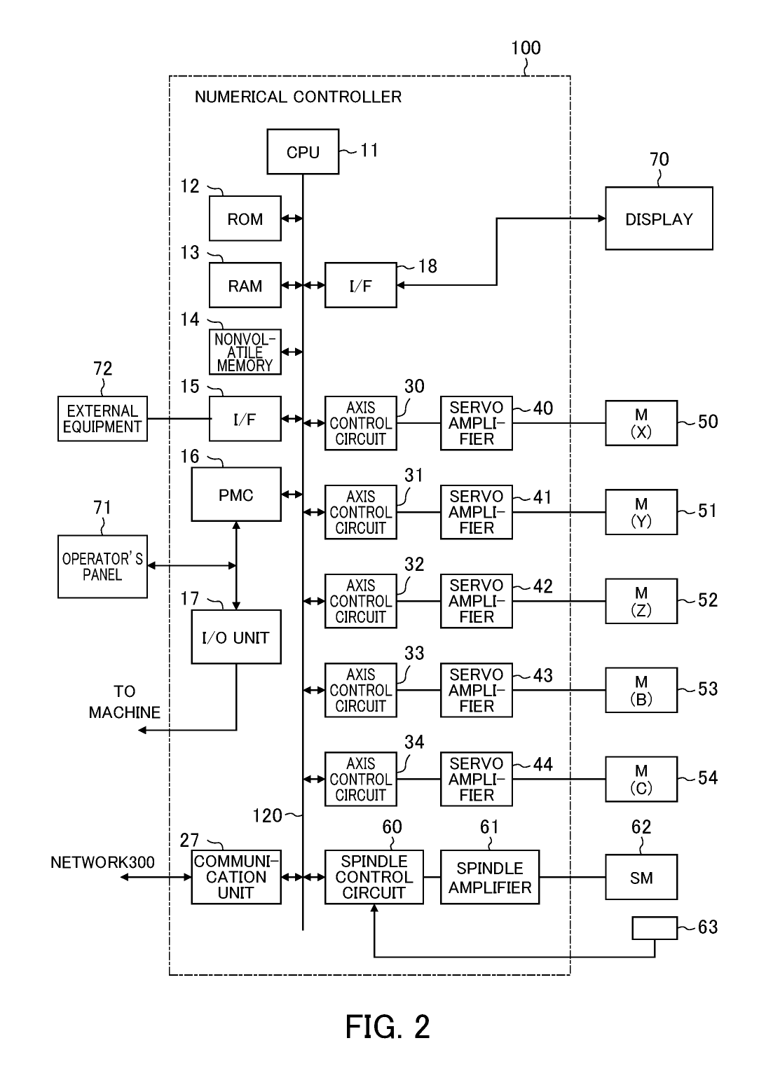

The numerical controller 100 controls, according to parameters and programs which are set, servo motors and the like included in the machine tool 200. FIG. 2 is a block diagram showing the hardware configuration of main portions of the numerical controller 100. In the numerical controller 100, a CPU 11 is a processor which comprehensively controls the numerical controller 100. The CPU 11 reads, through a bus 20, a system program stored in a ROM 12, and controls the entire numerical controller 100 according to the system program. In a RAM 13, temporary calculation data and display data and various types of data input by an operator through a display 70 are stored. Since access to a RAM is generally faster than access to a ROM, the system program stored in the ROM 12 may be previously deployed on the RAM 13, and the CPU 11 may read the system program from the RAM 13 and execute it. A nonvolatile memory 14 is a magnetic storage device, a flash memory, an MRAM, an FRAM (registered trademark), an EEPROM or an SRAM or DRAM which is backed up by an unillustrated battery, and is formed as a nonvolatile memory in which even when the power supply of the numerical controller 100 is turned off, its memory state is retained. In the nonvolatile memory 14, a machining program and the like, which are input through an interface 15, the display 70 or a communication unit 27, are stored. The interface 15 makes it possible to connect the numerical controller 100 and external equipment 72 together. The machining program, various types of parameters and the like are read from the side of the external equipment 72. The machining program edited within the numerical controller 100 can be stored in an external storage unit through the external equipment 72. The interface 15 may be present on the display 70. Examples of the external equipment 72 include a computer, a USB memory, a CFast, a CF card and an SD card.

A PMC (Programmable Machine Controller) 16 uses a sequence program incorporated in the numerical controller 100 so as to output a signal to an auxiliary device (for example, an automatic turret) of the machine tool through an I/O unit 17 and thereby perform control. The PMC 16 also receives the signals of various types of switches and the like in an operator's panel provided in the main body of the machine tool, performs necessary signal processing and. then feeds them to the CPU 11. The PMC 16 is also generally referred to as a PLC (Programmable Logic Controller). The operator's panel 71 is connected to the PMC 16. The operator's panel 71 may include a manual pulse generator and the like. The display 70 is a manual data input device which includes a display, a keyboard and the like. An interface 18 feeds display screen data to the display of the display 70, receives a command and data from the keyboard of the display 70 and feeds them to the CPU 11.

Axis control circuits 30 to 34 of individual axes receive movement command for the individual axes from the CPU 11, and output the commands for the individual axes to servo amplifiers 40 to 44. Servo amplifiers 40 to 44 receive the commands so as to drive servo motors 50 to 54 of the individual axes. Servo motors 50 to 54 of the individual axes incorporate position and speed detectors, feed back position and speed feedback signals from the position and speed detectors to the axis control circuits 30 to 34 and thereby perform feedback control on the positon and speed. In the block diagram shown in FIG. 2, the feedback of the positon and speed is omitted.

A spindle control circuit 60 receives a spindle rotation command for the machine tool so as to output a spindle speed signal to a spindle amplifier 61. The spindle amplifier 61 receives the spindle speed signal so as to rotate the spindle motor 62 of the machine tool at the commanded rotation speed and thereby drive a tool. A pulse encoder 63 is coupled to the spindle motor 62 with a gear, a belt or the like, the pulse encoder 63 outputs a feedback pulse in synchronization with the rotation of the spindle and the feedback pulse is read by the CPU 11 through the bus 20.

Examples of the machine tool 200 include a lathe, a milling machine, an electrical discharge machine, a grinding machine, a machining center and a laser machining machine.

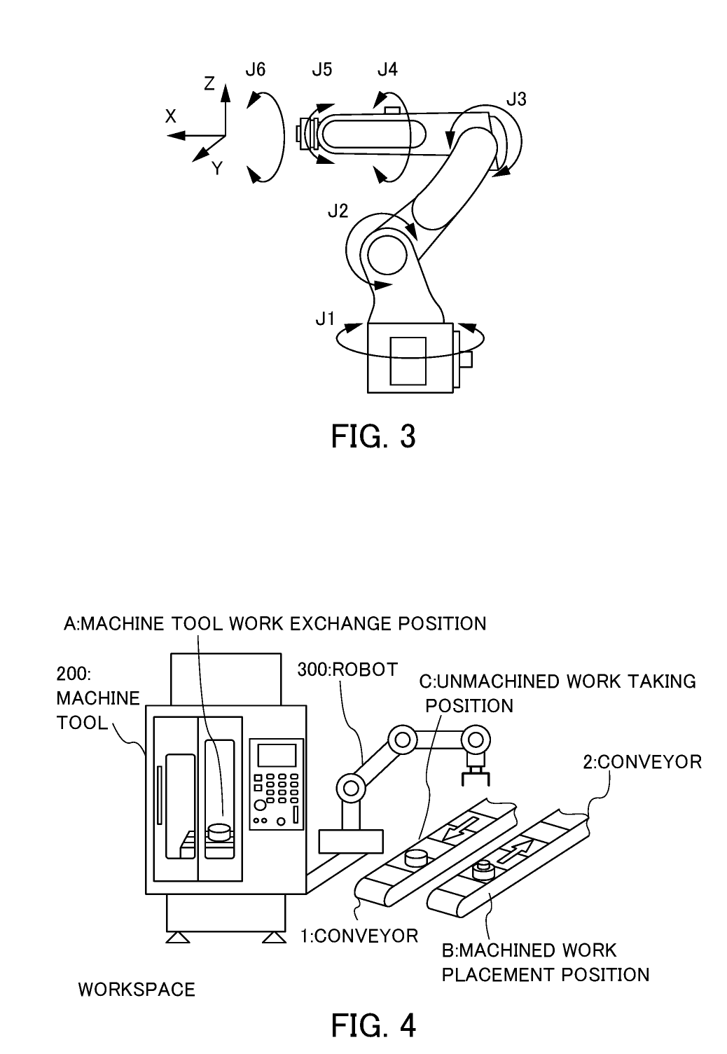

According to an operation command generated based on a robot operation program (hereinafter also simply referred to as an “operation program 460”) and the setting values of parameters set in the robot controller 400, for example, the robot 300 acquires an unmachined work placed in a work placement area, and the unmachined work is transported to a predetermined position in a delivery region on a work table of the machine tool 200. The robot 300 is, for example, a six-axis articulated robot. The drive axes of individual joint units and the drive axis of a hand unit 310 in the robot 300 are driven by a motor unit (unillustrated), and are controlled by the robot controller 400. As shown in FIG. 3, the robot 300 includes the six axes from a J1 axis to a J6 axis and the orthogonal axes of an X axis, a Y axis and a Z axis at the tip of the robot 300. FIG. 3 is a diagram showing the individual axes and the orthogonal axes in the robot 300. Here, the axes from the J1 axis to the J3 axis are referred to as basic axes, and axes from the J4 axis to the J6 axis are referred to as wrist axes, The robot 300 moves the individual axes and the orthogonal axes with the robot controller 400 so as to move the hand unit 310 to a predetermined position.

The robot controller 400 outputs, to the robot 300, the operational command generated based on the operation program 460 and the setting values of the parameters so as to make the robot 300 perform a predetermined operation. The general configuration of the robot controller 400 is substantially the same as that of the numerical controller 100 described with reference to FIG. 2 except that a teach pendant is used instead of the display 70, and thus the detailed description. thereof will be omitted.

In the production system 1000 of the present embodiment, for example, in a workspace, while the numerical controller 100 which controls the machine tool 200 and the robot controller 400 which controls the robot 300 coordinate with each other, the hand 310 of the robot 300 (also referred in short as the “robot 300” unless otherwise specified) is moved to a predetermined position.

FIG. 4 shows an example of the movement position of the robot 300. In FIG. 4, as the movement position of the robot 300, a machine tool work exchange position A, a machined work placement position B and an unmachined work taking position C are illustrated. In the case of this example, in the workspace, while the numerical controller 100 which controls the machine tool 200 and the robot controller 400 which controls the robot 300 coordinate with each other, the production system 1000 sequentially moves, for example, the robot 300 to the machine tool work exchange position A, to the machined work placement position B, to the unmachined work taking position C and then again to the machine tool work exchange position A in a cyclic manner. More specifically, the robot controller 400 moves, for example, the robot 300 to the machine tool work exchange position A within the machine tool, and makes the robot 300 remove a machined work from the machine tool work exchange position A. Then, the robot controller 400 moves the robot 300 to the machined work placement position B set on a conveyor 2 while the robot 300 is being made to grasp the machined work, and makes the robot 300 place the machined work in the machined work placement position B. Then, the robot controller 400 moves the robot 300 to the predetermined unmachined work taking position C where the unmachined work on a conveyor 1 is placed, and makes the robot 300 remove the unmachined work from the unmachined work taking position C. Then, the robot controller 400 moves the robot 300 to the machine tool work exchange position A while the robot 300 is being made to grasp the unmachined work, and makes the robot 300 fit the unmachined work to the machine tool work exchange position A. Thereafter, the numerical controller 100 controls the machine tool 200 so as to perform machining processing on the unmachined work, and then the robot controller 400 moves the robot 300 again to the machine tool work exchange position. A, and makes the robot 300 remove the machined work from the machine tool work exchange position A. Then, the robot controller 400 repeats a coordinated task such that the robot controller 400 moves the robot 300 to the machined work placement position B set on the conveyor 2 while the robot 300 is being made to grasp the machined work, and makes the robot 300 place the machined work in the machined work placement position B. In order for such an task to be performed, positions to which the robot 300 is moved are previously taught to the operation program of the robot controller 400, and thus it is necessary to set a movement path moving from a predetermined movement position to the subsequent movement position.

When the machine tool 200 and the robot 300 are made to coordinate with each other so as to perform machining processing, the positions to which the robot 300 is moved, that is, in the example described above, for example, the machine tool work exchange position A, the machined work placement. position B and the unmachined work taking position C are previously taught to the robot controller 400, and thus it is necessary to set, for the operation program, the movement path moving from the predetermined movement position to the subsequent movement position. In this way, the robot controller 400 uses the operation program 460 and thereby can control the robot 300 such that the robot 300 is moved to an appropriate position in the workspace. Although in the present embodiment, the teaching position is described based on the example discussed above, the teaching position of the robot 300 in the production system 1000 is not limited to this configuration.

### About the Setup Program

It is necessary to previously teach, to the robot controller 400, the positions to which the robot 300 is moved, that is, in the example described above, for example, the machine tool work exchange position A, the machined work placement position B and the unmachined work taking position C. Hence, in the present invention, in order to previously store individual teaching positions, the robot controller 400 includes, in a program storage unit 420, a plurality of setup programs 450 corresponding to the individual teaching positions. For example, when N teaching positions are present, the robot controller 400 includes N setup programs 450 corresponding to the teaching positions. For example, when the teaching position is set to the teaching position (i) (1≤i≤N), the setup program 450 (i) (1≤i≤N) for the teaching position (i) is included. When the setup program 450 (i) corresponding to the teaching position. (i) is started by using, as a trigger, an external signal (i) which is made to correspond to the setup program 450 (i), the position of the robot 300 at the time of the start (specifically, the position of the hand 310 in the robot 300) is stored in a register (i) which is previously made to correspond to the individual teaching position (i).

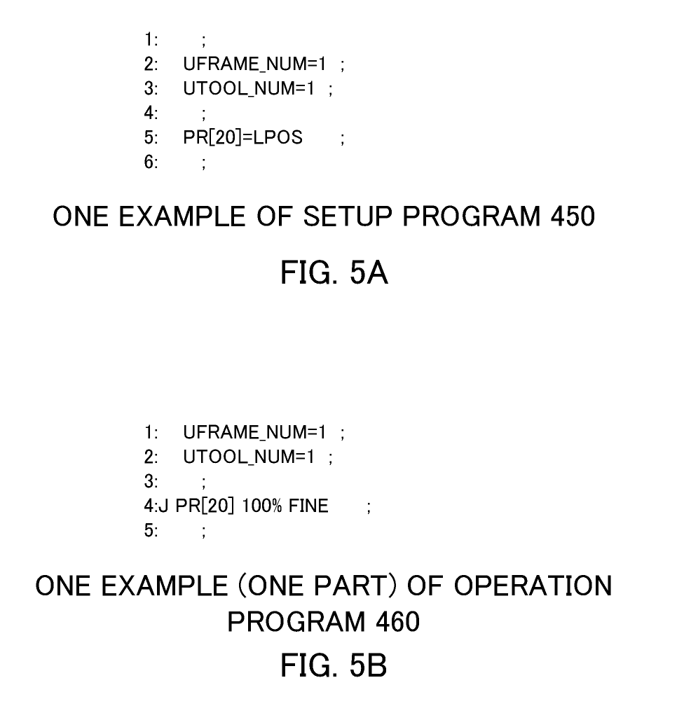

FIG. 5A shows an example of the setup program 450. As shown in FIG. 5A, the setup programs 450 corresponding to the individual teaching positions are configured such that positions when the setup programs 450 are started are stored in the registers corresponding to the individual teaching positions. The setup program 450 shown in FIG. 5A is configured such that when the setup program 450 is started, the position of the hand at the time of the start is stored in the 20th register as described in the 5th line.

### About the Operation Program

The robot controller 400 executes the operation program 460 previously produced so as to operate the robot 300. The operation program 460 is produced by setting an operation sequence for providing the instruction of the movement of the robot 300, necessary numerical parameters in individual operations and the like (for example, a movement speed and the like in the movement path) and the teaching positions. In the present embodiment, it is assumed that except the setting of the teaching positions, the operation sequence and the necessary numerical parameters in individual operations and the like in the operation program 460 are previously produced. FIG. 5B shows an example of the operation program 460. As shown in FIG. 5B, the operation program 460 is configured such that position registers corresponding to the individual teaching positions are referenced, and thus the position coordinate value of a destination is acquired. In the program example of FIG. 5B, a command for referencing the 20th register for positioning is described in the 4th line. Here, in the 20th register, as described previously, the position data of the individual axes is previously set by the setup program 450 for storing the teaching position which is made to correspond to the 20th register. In this way, when the operation program 460 is executed, the teaching position (the position data of the individual axes) stored in the 20th register is read, and thus the position operation of the individual axes in the robot 300 can be performed based on the teaching position (the position data of the individual axes).

Configurations which are included in the numerical controller 100 and the robot controller 400 in order to store the teaching positions in the setup programs 450 included in the robot 300 will be described next.

### Numerical Controller 100

With reference back to FIG. 1, as shown in FIG. 1, the numerical controller 100 includes a teaching position display control unit 110, a robot axis feed unit 120 and a signal transmission unit 140.

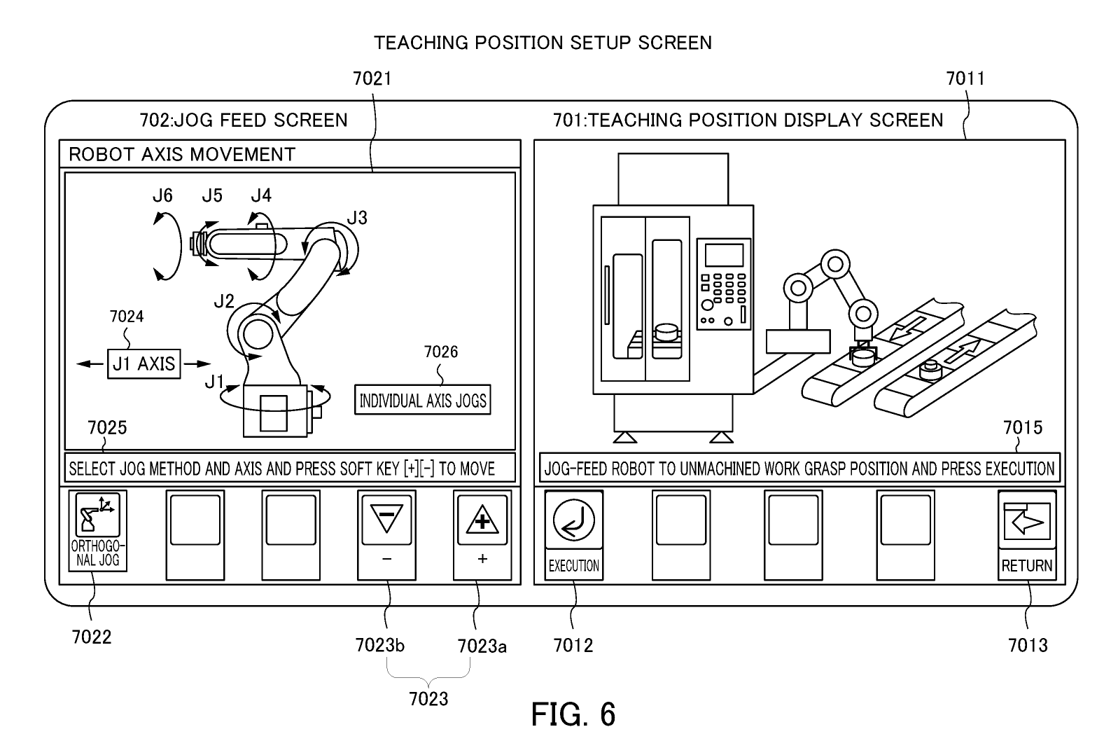

The teaching position display control unit 110 outputs, to the display of the display 70 serving as a display unit (hereinafter referred to as the “display”), a teaching position display screen 701 for displaying one teaching position which needs to be taught to the robot. 300. On the right side of FIG. 6, an example of the teaching position display screen 701 will be shown. As shown on the right side of FIG. 6, the teaching position display screen 701 includes a teaching position display region 7011 where the teaching position which needs to be taught this time is displayed, an execution button 7012, a return button 7013 and an instruction region 7015. The operator references the teaching position which is displayed in the teaching position display region 7011 and which needs to be taught this time and manually operates the robot 300 through a jog feed screen 702 which will be described later so as to move the robot 300 to the teaching position which needs to be taught this time. When the operator confirms that the robot 300 is moved to the teaching position which needs to be taught this time, the operator presses the execution button. 7012 displayed. on the teaching position display screen 701. The execution button 7012 is pressed, and thus an external signal for starting the setup program 450 corresponding to the teaching position which needs to be taught this time is generated. Thereafter, when the teaching position display control unit 110 transmits, through the signal transmission unit 140 to the robot controller 400, the external signal for starting the setup program 450 corresponding to the teaching position which needs to be taught this time, the teaching position display control unit 110 displays the teaching position which needs to be subsequently taught in the teaching position display region 7011, that is, the position to which the robot 300 needs to be subsequently moved. When the return button 7013 is pressed, the teaching position display screen 701 returns to the preceding teaching display screen. In this way, for example, it is possible to redo the teaching of the teaching position which is displayed. in the preceding teaching position display screen 701 and which needed to be taught last time. When the execution buttons 7012 corresponding to the individual teaching positions are sequentially pressed down, and then the execution button 7012 corresponding to the final teaching position is pressed, the teaching position display control unit 110 displays the completion of the teaching task in the teaching position display region 7011 and also displays a completion button 7014, which will be described later, instead of the execution button 7012. When the teaching position display control unit 110 detects that the completion button 7013 is pressed, the teaching position display control unit 110 completes the teaching position display control and, for example, may transfer to the initial screen.

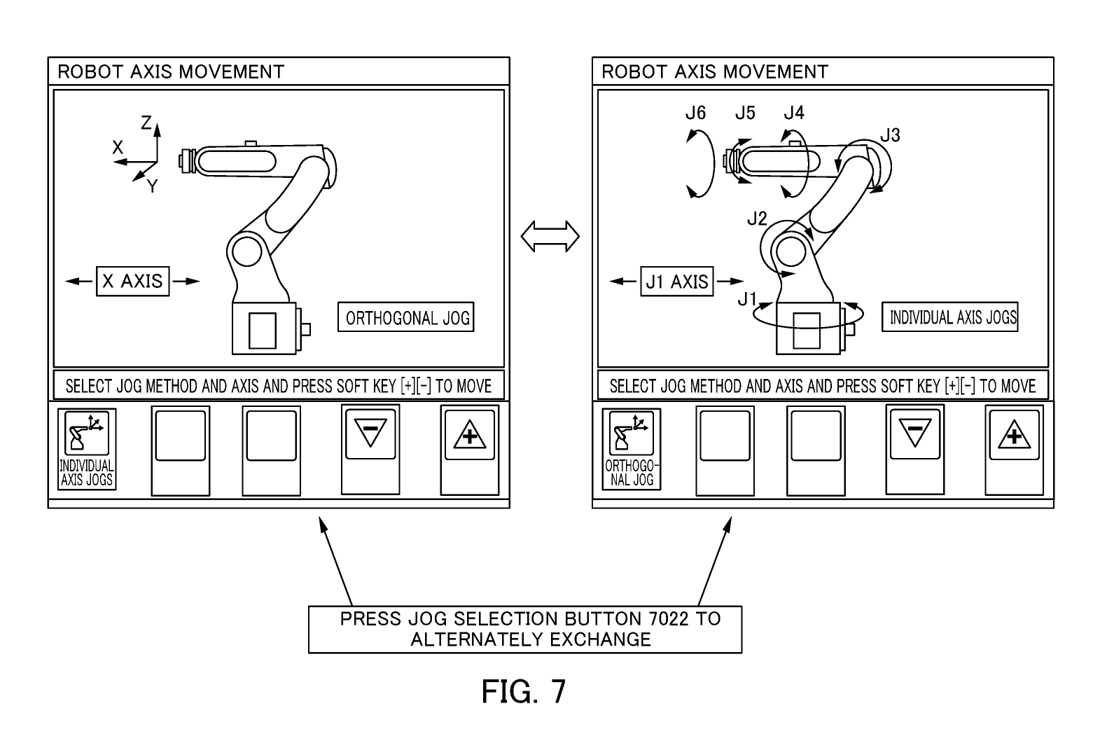

The robot axis feed unit 120 selects, on the display, the individual axes (from the J1 axis to the J6 axis) or the orthogonal axes (from the X axis to the Z axis) in the robot 300 and outputs the jog feed screen 702 for providing an instruction to move in a plus direction or a minus direction. On the left side of FIG. 6, an example of the jog feed screen 702 is shown. As shown on the left side of FIG. 6, the jog feed screen 702 includes a jog axis display region 7021, and includes a jog display box 7026 which displays the type of jog currently selected and an axis selection box 7024. The jog feed screen 702 also includes a jog selection button 7022 for selecting the type of jog for selecting an individual axis jog or an orthogonal jog, a movement direction. button 7023 and an instruction region 7025. The movement direction button 7023 includes, for example, a button 7023a for moving the robot 300 in the plus direction of the axis and a button 7023b for moving the robot 300 in the minus direction of the axis. When the type of jog is selected by the jog selection button 7022, the robot axis feed unit 120 displays, in the jog display box 7026, the type of jog selected. Furthermore, the axis selection box 7024 makes it possible to select any one of the axes from the J1 axis to the J6 axis (when the type of jog is the individual axes) and makes it possible to select any one of the axes from the X axis to the Z axis (when the type of jog is the orthogonal axes). FIG. 7 shows how the type of jog is selected by the jog selection button 7022 and how the axis is selected by the axis selection box 7024. As shown in FIG. 7, when the individual axes are selected by the axis selection button 7022, the robot axis feed unit 120 displays, in the axis selection box 7024, a box with which it is possible to select any one of the axes from the J axis to the J6 axis. When the orthogonal axes are selected by the jog selection button 7022, the robot axis feed unit 120 displays, in the axis selection box 7024, a box with which it is possible to select any one of the axes from the X axis to the Z axis. When any one of the axes from the J1 axis to the J6 axis (in a case where the type of jog is the individual axes) or any one of the axes from the X axis to the Z axis (in a case where the type of jog is the orthogonal axes) is selected by the axis selection box 7024, the robot axis feed unit 120 commands, in response to an operation on the movement direction button 7023 (the button 7023a or the button 7023b) while the movement direction button of the selected axis is being pressed, the robot controller 400 to move the axis in the direction of the selected movement direction button in this way, the operator can move the robot 300 by a jog operation based on one teaching position which is displayed on the teaching position display screen 701 and which needs to be taught this time. Then, as described previously, when the operator confirms that the robot 300 is moved to the teaching position which needs to be taught this time, and the teaching position display control unit 110 detects that the execution button 7012 displayed on the teaching position display screen 701 is pressed, the external signal for starting the setup program 450 corresponding to the teaching position which needs to be taught this time is generated, and is transmitted through the signal transmission unit 140 to the robot controller 400. In this way, in the robot controller 400, the external signal is used as a trigger such that the setup program 450 which is previously assigned to the external signal and which corresponds to the teaching position is started, and the position of the robot 300 at the time of the start (specifically, the position of the hand 310 in the robot 300) is stored in the register which is previously made to correspond to the teaching position.

As described previously, the signal transmission unit 140 transmits, in response to the pressing of the execution button 7012 displayed on the teaching position. display screen 701, the external signal generated by the teaching position display control unit 110 to the robot controller 400.

### Robot Controller 400

The robot controller 400 will be described next. As shown in FIG. 1, the robot controller 400 includes a signal reception. unit 410, a program start unit 420 and a program storage unit 430.

The signal reception unit 410 receives the external signal which is transmitted from the numerical controller 100 (the signal transmission unit 140) and which is used for starting the setup program 450 corresponding to a predetermined teaching position.

The program start unit 420 starts the setup program 450 by the macro start of the setup program 450 which is previously assigned to the external signal received in the signal reception unit 410 and which corresponds to the predetermined teaching position, and executes the setup program 450. As described previously, when the setup program 450 corresponding to the predetermined teaching position is started, the position of the robot 300 at the time of the start (specifically, the position of the hand 310 in the robot 300) is stored in the register which is previously made to correspond to the teaching position. In this way, the teaching position (the position data of the individual axes) is stored in the register which is made to correspond to the teaching position.

In the program storage unit 430, the setup programs 450 corresponding to the individual teaching positions and the operation program 460 of the robot 300 are previously stored. In the practice of the invention in the present application, for example, the setup programs 450 and the operation program 460 of the robot 300 can be prepared on the side of a manufacturer, the external signal can be previously assigned to the setup program 450 corresponding to the predetermined teaching position and thus the user can easily perform the position teaching of the robot. Then, when the start of the setup programs 450 corresponding to all the teaching positions is completed, the robot controller 400 can be made to execute the operation program 460.

The flow of processing when the positron teaching on the robot controller 400 is performed from the numerical controller 100 will next be described by use of a specific example. In the operation sequence of the system in this example, a coordinated task is repeated in which (1) the robot 300 is moved to the machine tool work exchange position A within the machine tool and is made to grasp the machined work whose machining is completed in the machine tool 200, (2) while the robot 300 is being made to grasp the machined work, the robot 300 is moved to the machined work placement position B on the conveyor and is made to place the machined work in the machined work placement position B, (3) the robot 300 is moved to the unmachined work taking position. C on the conveyor and is made to grasp the unmachined work, (4) while the robot 300 is being made to grasp the unmachined work, the robot 300 is moved to the machine tool work exchange positron A within the machine tool and is made to fit the unmachined work to the machine tool 200 and thereafter the numerical controller 100 controls the machine tool 200 so as to perform machining processing on the unmachined work, then again (1) the robot controller 400 moves the robot 300 to the machine tool work exchange position A within the machine tool and makes the robot 300 remove the machined work from the machine tool work exchange position A and (2) while the robot 300 is being made to grasp the machined work, the robot 300 is moved to the machined work placement positron B set on the conveyor 2 and is made to place the machined work in the machined work placement position B.

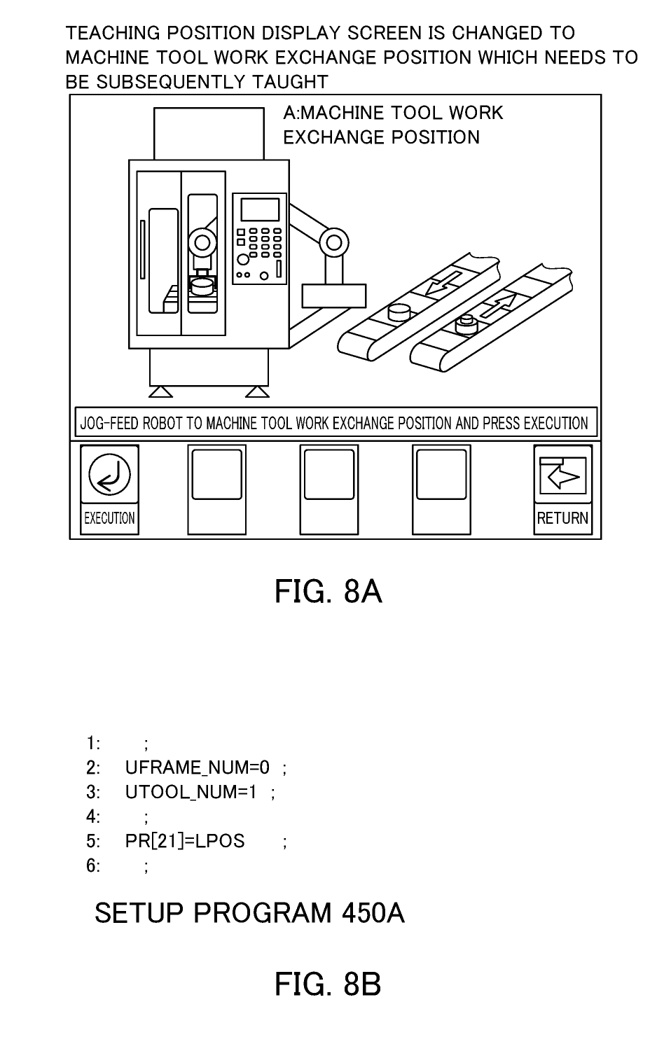

FIGS. 8A, 9A, 10A and 11A are diagrams showing examples of the teaching position display screen corresponding to the operation sequence of the robot. FIGS. 8B, 9B and 10B are diagrams showing examples of the setup program 450 started by the teaching position display screen corresponding to the operation sequence of the robot. The processing of the position teaching on the robot controller 400 will be described below with reference to FIGS. 8A to 11.

As shown in FIG. 8A, the numerical controller 100 (the teaching position display control unit 110) displays, on the right side of the display, the teaching position display screen 701 for teaching the machine tool work exchange position A within the machine tool 200. In regard to this, the operator manually operates the robot 300 through the jog feed. screen 702 displayed by the numerical controller 100 (the robot axis feed unit 120) so as to move the robot 300 to the machine tool work exchange position A within the machine tool 200. In response to the confirmation of the movement of the robot 300 to the machine tool work exchange position A within the machine tool and the pressing of the execution button 7012 displayed on the teaching position display screen 701 by the operator, the teaching position display control unit 110 generates an external signal for starting a setup program 450A corresponding to the machine tool work exchange position A serving as the teaching position which needs to be taught this time and turns it on for a given time.

When the robot controller 400 (the signal reception. unit 410) receives the external signal, the setup program 450A which is stored in the program storage unit 430 and which corresponds to the machine tool work exchange position A is started by the external signal. As shown in FIG. 8B, the setup program 450A corresponding to the machine tool work exchange position A stores, as described in the 5th line, in a position register [21] which is the 21st register, the position data of the robot 300 at that time (that is, the position data of the machine tool work exchange position A).

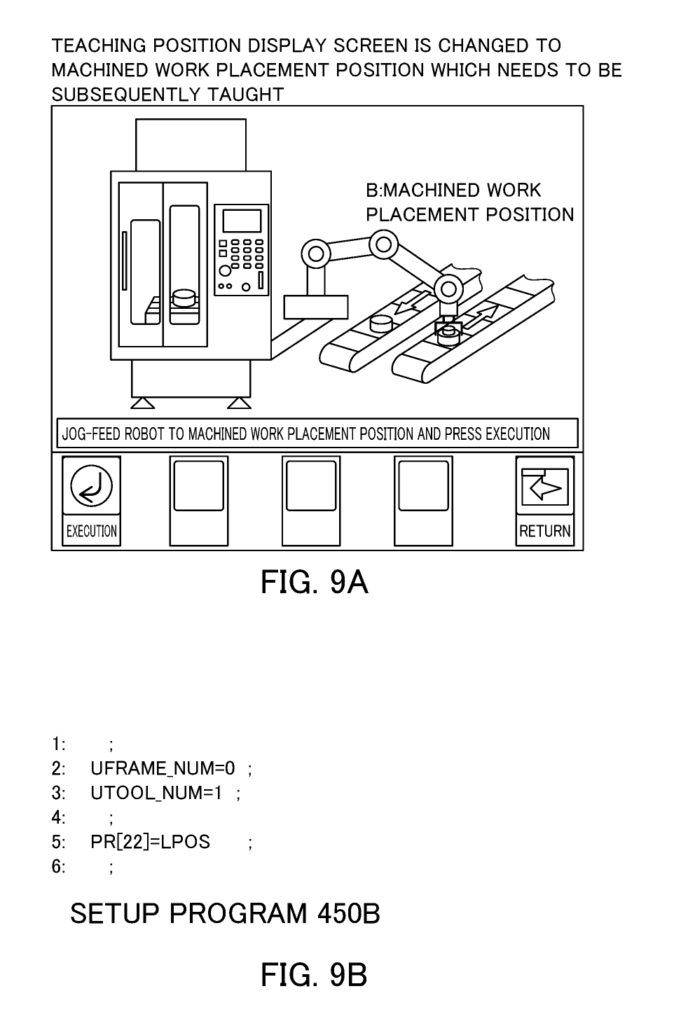

Then, the numerical controller 100 (the teaching position display control unit 110) displays, as shown in FIG. 9A, the teaching position display screen 701 which displays the machined work placement position B on the conveyor 2 that is the subsequent teaching position. The operator manually operates the robot 300 through the jog feed screen 702 displayed by the numerical controller 100 (the robot axis feed unit 120) so as to move the robot 300 to the machined work placement position B on the conveyor 2. In response to the confirmation of the movement of the robot 300 to the machined work placement position B on the conveyor 2 and the pressing of the execution button 7012 displayed on the teaching position display screen 701 by the operator, the teaching position display control unit 110 generates an external signal for starting a setup program 450B corresponding to the machined work placement position B on the conveyor 2 serving as the teaching position which needs to be taught this time and turns on for a given time.

When the robot controller 400 (the signal reception unit 410) receives the external signal, the setup program 450B corresponding to the machined work placement position B on. the conveyor 2 is started. As shown in FIG. 9B, the setup program 450B corresponding to the machined work placement position B stores, as described in the 5th line, in a position register [22] which is the 22nd register, the position data of the robot 300 at that time (that is, the position data of the machined work placement position B on the conveyor 2).

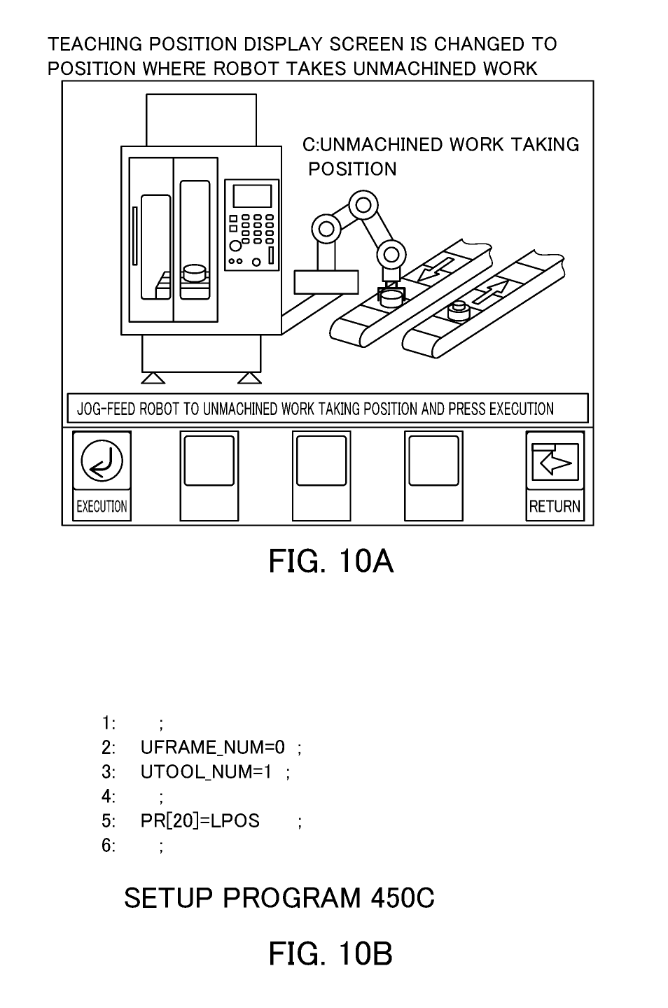

Then, the numerical controller 100 (the teaching position display control unit 110) displays, as shown in FIG. 10A, a teaching position display screen 901 which displays the unmachined work taking position C on the conveyor 1 that is the subsequent teaching position. The operator manually operates the robot 300 through the jog feed screen 702 displayed by the numerical controller 100 (the robot axis feed unit 120) so as to move the robot 300 to the unmachined work taking position C on the conveyor 1. In response to the confirmation of the movement of the robot 300 to the unmachined work taking position C on the conveyor 1 and the pressing of the execution button 7012 displayed on the teaching position display screen 701 by the operator, the teaching position display control unit 110 generates an external signal for starting a setup program 450C corresponding to the unmachined work taking position C on the conveyor 1 serving as the teaching position which needs to be taught this time and turns it on for a given time.

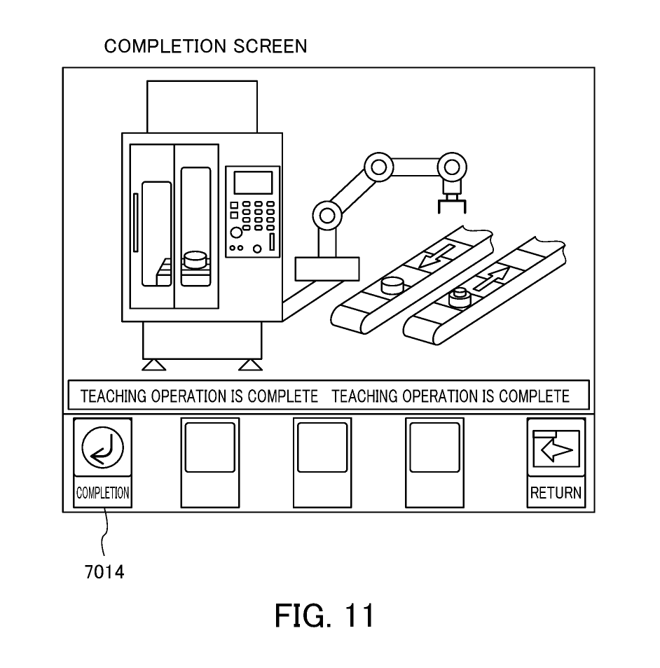

When the robot controller 400 (the signal reception unit 410) receives the external signal, the setup program 450C corresponding to the unmachined work taking position C on the conveyor 1 is started. by the external signal. As shown in FIG. 10B, the setup program 450C corresponding to the unmachined work taking position C on the conveyor 1 stores, as described in the 5th line, in a position register [20] which is the 20th register, the position data of the robot 300 at that time (that is, the unmachined work taking position C on the conveyor 1). Then, the numerical controller 100 (the teaching position. display control unit 110) displays, as shown in FIG. 11, a completion screen, whereby teaching of all the teaching positions is completed.

As described above, the setup program 450A, the setup program 450B and the setup program 450C are sequentially started by the external signal, and thus the position data of the machine tool work exchange position A is stored in the position register [21], then the position data of the machined work placement position B on the conveyor is stored in the position register [22] and then the unmachined work taking position C on the conveyor is stored in the position register [20].

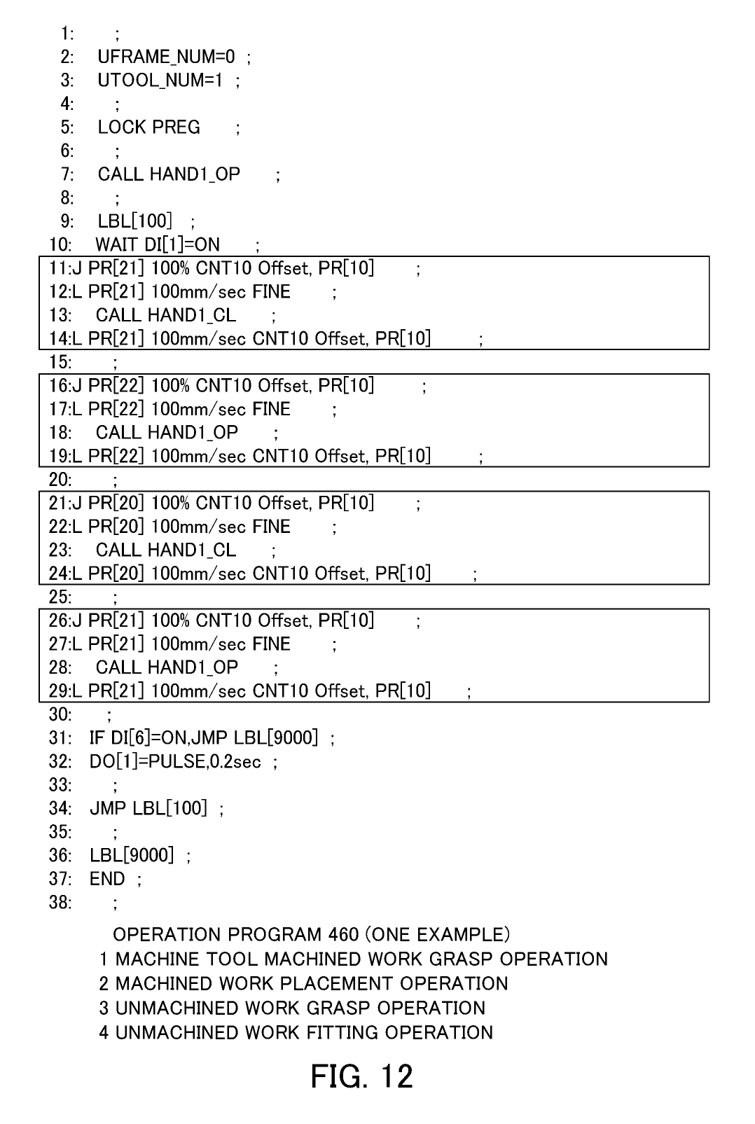

The operation program 460 of the robot 300 which is executed after the position data is stored in each of the position registers [20] to [22] will be described next. FIG. 12 is a diagram showing an example of the operation program 460 corresponding to the operation sequence of the robot. In lines from the 11th line to the 14th line, the operation program 460 performs an operation in which (1) the robot 300 is moved to the machine tool work exchange position A within. the machine tool and is made to grasp the machined work whose machining is completed in the machine tool 200. Here, the position register [21] in which the position data of the machine tool work exchange position A is stored is used. Then, in lines from the 16th line to the 19th line, the operation program 460 performs an operation in which (2) while the robot 300 is being made to grasp the machined work, the robot 300 is moved to the machined work placement position B on the conveyor 2 and is made to place the machined work in the machined work placement position B. Here, the position register [22] in which the position data of the machined work placement position B on the conveyor 2 is stored is used. Then, in lines from the 21st line to the 24th line, the operation program 460 performs an operation in which (3) the robot 300 is moved to the unmachined work taking position C on the conveyor 1 and is made to grasp the unmachined work. Here, the position register [20] in which the position data of the unmachined work taking position C on the conveyor 1 is stored is used. Then, in lines from the 26th line to the 29th line, the operation program 460 performs an operation in which (4) while the robot 300 is being made to grasp the unmachined work, the robot. 300 is moved. to the machine tool work exchange position A within the machine tool and is made to fit the unmachined work to the machine tool 200. Here, the position register [21] in which the position data of the machine tool work exchange position A is stored is used. Thereafter, the numerical controller 100 controls the machine tool 200 so as to perform machining processing on the unmachined work, and then the operation program 460 transfers again to a label

in the 9th line so as to perform again the operation in which (1) the robot 300 is moved to the machine tool work exchange position A within the machine tool and is made to grasp the machined work whose machining is completed in the machine tool 200. Here, the position register [21] in which the position data of the machine tool work exchange position A is stored is used. Thereafter, the operation program 460 performs such repeated processing, and completes a movement operation when the external signal (DI signal) is a cycle stop request as described in the 31st line.

As described above, the operation program 460 which is configured such that the operation sequence and the necessary numerical parameters in individual operations and the like are previously produced and that the position registers corresponding to the teaching positions are referenced so as to acquire the position data of the teaching positions and the setup program 450 which is started for each of the teaching positions so as to store the teaching position data (serving as the teaching position) in the position register corresponding to the teaching position are prepared, and thus it is possible to simply perform the teaching of the movement position included in the task of producing the robot operation program 460. As described above, in the production system 1000, it is possible to simply perform the teaching of the movement position included in the task of producing the operation program 460.

Furthermore, in the present embodiment, between the signal generated on the side of the machine tool (the numerical controller 100) and the side of the robot (the robot controller 400), for example, PLC software or a logic circuit is used so as to assign the signal, and thus the setup program 450 is started. In this way, without need to add a special configuration and a modification to the machine tool (the numerical controller 100) and the robot (the robot controller 400), with the existing configuration, it is possible to the present invention By utilization of the assignment of the signal with PLC software or a logic circuit which a person skilled in the art is used to handling, the person skilled in the art who is used to handing the machine tool (the numerical controller 100) can easily practice the present invention.

The programs such as the operation program 460 which are used in the present invention are stored using various types of non-transitory computer readable media and can be supplied to computers. The non-transitory computer readable media include various types of tangible storage media. Examples of the non-transitory computer readable medium include magnetic storage media (for example, a flexible disk, a magnetic tape and a hard disk drive), magneto-optical storage media (for example, a magneto-optical disk), a CD-ROM (Read Only Memory), a CD-R, a CD-R/W, semiconductor memories (for example, a mask ROM, a PROM (Programmable ROM), an EPROM (Erasable PROM), a flash ROM and a RAM (random access memory)). The programs may be supplied to computers with various types of transitory computer readable media. Examples of the transitory computer readable medium include an electrical signal, an optical signal and an electromagnetic wave. The transitory computer readable media can supply the programs to computers through wired communication paths such as an electrical wire and an optical fiber or wireless communication paths.

Although the present embodiment is a preferred embodiment of the present invention, the scope of the present invention is not limited to only the embodiment described above, and the present invention can be practiced by providing various modifications without departing from the spirit of the present invention.

### Variation 1

Although in the present embodiment, the numerical controller 100 generates the external signal to the robot controller 400, this is not limited to the numerical controller. For example, instead of the numerical controller 100, arbitrary external equipment such as a PC or a tablet machine can be used.

### Variation 2

Although in the present embodiment, as the teaching positions, the machine tool work exchange position A, the machined work placement position B on the conveyor and. the unmachined work taking position C on the conveyor are illustrated, teaching positions are not limited to these positions. As described previously, an arbitrary number of teaching positions (N teaching positions) may be present. In this case, in order to correspond to the teaching positions, N different. setup programs, N different position registers and N different external signals are previously produced (prepared), and thus the operator can easily perform the position teaching as in the present embodiment.

### Variation 3

Although in the present embodiment, as various types of operation buttons, for example, the touch buttons provided on the display are illustrated, buttons are not limited to these. As the operation buttons, for example, operation buttons on a keyboard may be applied.

### Variation 4

Although in the present embodiment, the configuration is illustrated in which the interface of the jog feed screen is provided on the display unit of the external equipment (for example, the numerical controller 100) and in which the jog feed operation on the robot 300 is performed, there is no limitation to this configuration. As the teaching means for the position teaching on the robot 300, an arbitrary known means may be applied. For example, the robot 300 may be operated by a manual operation so as to have a desired positon posture for teaching. The jog feed operation may be performed based on a key operation on an operation key (jog movement key) provided on the teach pendant connected to the robot controller 400.

### Variation 5

Although in the description or the present embodiment, the numerical controller 100 controls the one machine tool 200, there is no limitation to this configuration. The numerical controller 100 may control a plurality of machine tools 200. The robot controller 400 may also control a plurality of robots 300. Furthermore, a plurality of numerical controllers 100 and a plurality of robot controllers 400 may be connected to each other through a network.

### Variation 6

Although in the present embodiment, the example is described where in the robot controller 400, for example, the one operation program 460 is stored, there is no limitation to this example. In the robot controller 400, a plurality of operation programs 460 may be stored. In this case, a group of setup programs corresponding to the operation. programs 460 are prepared, and thus it is possible to achieve the same effects as in the specific examples of the present embodiment.

### EXPLANATION OF REFERENCE NUMERALS

100 Numerical controller
110 Teaching position. display control unit
↔Robot axis feed unit
140 Signal transmission unit
200 Machine tool
300 Robot
310 Hand unit
400 Robot controller
410 Signal reception unit
420 Program start unit
430 Program storage unit
1000 Production system

What is claimed is:

1. A robot controller which controls a robot, the robot controller comprising:
external equipment which is connected so as to be able to perform communication;
a signal reception unit which receives a preset external signal from the external equipment;
a program storage unit which stores a setup program that is previously made to correspond to the external signal; and
a program start unit which starts the setup program that is previously made to correspond to the external signal when the program start unit receives the external signal from the external equipment through the signal reception unit,
wherein when the setup program is started, a current position of the robot is used as a teaching position to be stored in a position register previously set in the setup program.

2. The robot controller according to claim 1, wherein the external equipment includes:
a display unit;
a teaching position display control unit which displays, on the display unit, only a teaching position that needs to be taught this time to the robot;
a robot axis feed unit which operates an axis of the robot; and
a signal transmission unit which transmits, to the robot controller, the external signal that is previously made to correspond to the teaching position, and
the teaching position display control unit displays, on the display unit, only a teaching position that needs to be subsequently taught to the robot when the signal transmission unit transmits the external signal to the robot controller.

3. The robot controller according to claim 2, wherein the teaching position display control unit further displays completion of position. teaching on the display unit when the signal transmission unit transmits, to the robot controller, the external signal that is made to correspond to a final teaching position.

4. The robot controller according to claim 1,
wherein the program storage unit further stores a robot operation program for moving the robot,
the program start unit further starts the robot operation program and
when the robot operation program is started, calls the position register in which the teaching position is stored by the setup program.

5. The robot controller according to claim 1, wherein the external equipment is a machine tool controller.

6. A production system comprising: a robot controller which controls a robot; and
a machine tool controller which is connected to the robot controller so as to control a machine tool that is used by being combined with the robot,
wherein the machine tool controller includes:
a display unit;
a teaching position display control unit which displays, on the display unit, only a teaching position that needs to be taught this time to the robot;
a robot axis feed unit which operates an axis of the robot; and
a signal transmission unit which transmits, to the robot controller, an external signal that is previously made to correspond to the teaching position,
the teaching position display control unit displays, on the display unit, only a teaching position that needs to be subsequently taught to the robot. when the signal transmission unit transmits the external signal to the robot controller,
the robot controller includes:
a signal reception. unit which receives the preset external signal from the machine tool controller;
a program storage unit which stores a setup program that is previously made to correspond to the external signal; and
a program start unit which starts the setup program that is previously made to correspond to the external signal when the program start unit receives the external signal from the machine tool controller through the signal reception unit and
when the setup program is started, a current position of the robot is used as a teaching position to be stored in a position register previously set in the setup program.
